(19) United States
(12) Patent Application Publication
(10) Pub. No.: US 2026/0071604 A1
(43) Pub. Date: Mar. 12, 2026

(54) GRADED UNDERGROUND PUMPED-STORAGE HYDROPOWER IN COAL MINE, CONSTRUCTION AND USING METHODS

(71) Applicant: Taiyuan University of Technology, Taiyuan (CN)

(72) Inventors: Xianjie DU, Taiyuan (CN); Ningze YANG, Taiyuan (CN); Yike BU, Taiyuan (CN); Guorui FENG, Taiyuan (CN); Qipeng HUANG, Taiyuan (CN)

(73) Assignee: Taiyuan University of Technology, Taiyuan (CN)

(21) Appl. No.: 19/387,621

(22) Filed: Nov. 13, 2025

(30) Foreign Application Priority Data
Aug. 1, 2025 (CN) 202511079712.1

(51) Int. Cl. F03B 13/06; E21F 17/103; E21F 17/16

(52) U.S. Cl. CPC F03B 13/06; E21F 17/103; E21F 17/16; F05B 2260/422

(57) ABSTRACT

The present disclosure provides a graded underground pumped-storage hydropower system in a coal mine, and construction and methods of use. The system comprises a surface reservoir, wherein multi-stage stepped underground reservoirs are arranged below the surface reservoir, and there is no communication between the multi-stage stepped underground reservoirs. One side of the underground reservoir on each layer is provided with a hydraulic turbine room, and an upward water conveyance passageway and a downward water conveyance passageway are arranged between the hydraulic turbine room and each underground reservoir. Additional water conveyance passageways are arranged between the hydraulic turbine rooms among the layers. During use, the present disclosure can achieve multi-grade power generation and energy storage capabilities by controlling sluice gates, adjusting water flow directions as required.

### TECHNICAL FIELD

The present disclosure belongs to the technical field of development and utilization of underground space in coal mines, particularly a graded underground pumped-storage hydropower in a coal mine, construction and using methods.

### BACKGROUND

In the past, the overexploitation of coal mine resources using the fallen method has resulted in a series of environmental problems, such as surface subsidence and soil erosion. In order to solve these problems and respond to the call of the state to protect the environment, coal mine backfilling mining technology has been widely used.

Nevertheless, there are still some problems in coal mine backfilling mining technology, such as high backfilling cost, a large material consumption, and a low utilization rate of underground space in the goaf. To solve these problems, constructional backfill mining technology is proposed (FENG Guorui, DU Xianjie, GUO Yuxia et al., Basic theory of constructional backfill mining and the underground space utilization concept [J], Journal of China Coal Society, 2019, 44 (01): 74-84.). Based on the distribution of coal seams and the characteristics of surrounding rock, this method of backfilling mining controls the movement and deformation of overlying rock strata by arranging constructional backfill columns at key locations in the goaf through pre-mining planning and solid waste resource utilization. Furthermore, this mining method can construct a large amount of long-term stable underground space in the goaf of coal mines, allowing for utilization according to specific requirements.

In China, the mine water produced by a ton of coal mining is 1.87 m³, the annual produced coal mine water is approximately 6.88×109 m³, and the average utilization rate of coal mine water is approximately 35%. Coal mine water represents a long-term, stable, and unconventional water resource for China, as the efficient utilization of mine water has significant socio-economic benefits. Due to the problem of mine water quality, it is difficult to directly merge into the surface domestic water pipeline. Consequently, the utilization of mine water needs to be solved urgently. Mine water can be configured as storage water for underground pumped-storage hydropower. On the one hand, it can be configured as an energy storage medium. On the other hand, due to the purification effect of rock strata, the water quality of mine water can be improved to achieve the objective of water purification.

Meanwhile, there is a serious imbalance between the demand and supply sides of electricity in China as well as worldwide. The power demand side presents a tide phenomenon of high in the morning and low in the evening. In order to ensure the stability of the power system, the supply side requires maintaining a balance with the demand side in real time. Therefore, the supply side needs to be regulated, which consumes a lot of manpower and material costs. The underground pumped-storage hydropower in coal mines can store excess energy of the power grid by pumping water during low power consumption valleys, and release energy during peak power consumption, which alleviates pressure on the power grid, achieves peak cut for power fluctuations, thereby achieving the objective of stabilizing the power grid.

In view of the foregoing, the construction of a graded underground pumped-storage hydropower in a coal mine using constructional backfill mining will be a solution that both saves money and alleviates water and energy shortages.

### SUMMARY

An objective of the present disclosure is to provide a graded underground pumped-storage hydropower in a coal mine, construction and using methods. By reasonably planning the coal mine, constructional backfill mining is performed, and the underground space of the coal mine is obtained. Leveraging its advantages of a stable internal environment, low impact from the surface environment, and abundant spatial resources, the construction of the graded underground pumped-storage hydropower is performed. The flexible control of different power generation and energy storage requirements is achieved.

In order to achieve the above objective, the present disclosure provides a construction method for a graded underground pumped-storage hydropower in a coal mine, which includes the following steps:
confirming a position and a number of underground reservoirs based on geological conditions of a mine, and roof and floor conditions of a working face;
confirming a width of a protective coal pillar between a production roadway and the working face based on a mine pressure behavior law, and planning a mining sequence;
after confirming the position of the underground reservoir, confirming a position of a hydraulic turbine room on one side of the underground reservoir in this layer, and excavating a pedestrian roadway and the hydraulic turbine room into the rock strata through the production roadway;
performing a constructional backfill mining on the coal mine based on the confirmed position of the underground reservoir, and when coal resources are mined to form the underground reservoir, it is backfilled to form a backfill column as required;
excavating an upward water conveyance passageway and a downward water conveyance passageway between the hydraulic turbine room and the underground reservoir on each layer; excavating a second water pipeline between the hydraulic turbine room among layers; excavating a first water pipeline between a surface reservoir and a first layer hydraulic turbine room; there is no requirement to construct a downward water conveyance passageway in the underground reservoir at a lowest layer;
arranging sluice gates at both ends of the first water pipeline, the second water pipeline, the upward water conveyance passageway and the downward conveyance water pipeline; and
performing an anti-leakage treatment on a goaf and connections of various parts to prevent water body leakage, and obtaining a well-constructed graded underground pumped-storage hydropower.

In some embodiments, a roof and a floor of the goaf are required to be hard rock strata and are aquifuge or aquitard, and when the roof and floor conditions are not satisfied, the water-proof material is used to perform a water-proof and anti-leakage treatment on the goaf; the anti-leakage treatment includes one or more of arranging a water-proof foam layer, spraying water-proof concrete and laying water-proof materials.

In some embodiments, each layer of the underground reservoir is provided with a staggered spacing according to mining requirements and safety requirements, and each layer of the underground reservoir is further provided with a longitudinal staggered spacing-free arrangement.

In some embodiments, the goaf is formed in the mining of the working face, and the mining and backfilling of the working face are performed simultaneously, the backfill column is formed by backfilling, and an immediate roof-backfill column-immediate floor structure is formed, where the backfill columns are arranged at intervals in the goaf, and a diameter of the backfill column is 1˜4 m.

In some embodiments, the backfill material used for the backfill column is cemented gangue backfill material or other backfill material that satisfies the load-bearing requirements, and reinforcing materials or components and anti-erosion materials can be added to the backfill material according to the load-bearing requirements and anti-erosion requirements.

In some embodiments, the hydraulic turbine room is located below a level of the underground reservoir of each layer and is arranged in the rock stratum.

In some embodiments, a water body in the underground reservoir is derived from fault water, aquifer water, or goaf water.

In some embodiments, a communication between the reservoir and the hydraulic turbine room is controlled by opening and closing the sluice gate, thereby controlling a number of stages of the hydraulic turbine room that the water flows through.

The present disclosure relates to a graded underground pumped-storage hydropower in a coal mine, which includes a surface reservoir, wherein multi-stage stepped underground reservoirs are arranged below the surface reservoir, and there is no communication between the multi-stage stepped underground reservoirs;
one side of the underground reservoir on each layer is provided with a hydraulic turbine room, and an upward water conveyance passageway and a downward water conveyance passageway are arranged between the hydraulic turbine room and the underground reservoir;
a second water pipeline is arranged between the hydraulic turbine rooms among the layers; a first water pipeline is arranged between the surface reservoir and the first layer hydraulic turbine room;
one end of the underground reservoir on each layer is provided with a production roadway and a pedestrian roadway, and sluice gates are arranged at connections among the production roadway, the pedestrian roadway, the upward water conveyance passageway, the downward water conveyance passageway and the underground reservoir;
the pedestrian roadway is further communicated with the hydraulic turbine room;
the other side of the underground reservoir is provided with a backfill column, the backfill column is configured to support the roof of the underground reservoir.

A using method for a graded underground pumped-storage hydropower in a coal mine is provided, when the underground reservoir is set to three grades, it includes an upper reservoir, an intermediate reservoir and a lower reservoir;
when a power generation capacity of a power grid is lower than a power load, a graded power generation function is started:
when the power load is high, a third-stage hydraulic turbine room is started to generate electricity, and the connection between the upper reservoir and the intermediate reservoir with the hydraulic turbine room is cut off by closing the sluice gate close to a side of the hydraulic turbine room, so that the water body of the surface reservoir is directly allocated to the hydraulic turbine room of the corresponding layer of the lower reservoir, and flows through the third-stage hydraulic turbine room for maximum power generation;
when the power load is low, a second-stage hydraulic turbine room or first-stage hydraulic turbine room is started to generate electricity; when the second-stage hydraulic turbine room is used, the sluice gate close to a side of the hydraulic turbine room is closed, a connection between the intermediate reservoir and the hydraulic turbine room is cut off, and the water body of the upper reservoir is allocated to the lower reservoir and flows through the second-stage hydraulic turbine room; when the first-stage hydraulic turbine room is used, only water body is allocated between adjacent layers.

In some embodiments, when the power generation capacity of the power grid is higher than the power load, the graded energy storage function is started, which includes:
when there is a lot of remaining electric energy in the power grid, the third-stage hydraulic turbine room is used for energy storage, and a layer-by-layer transportation or direct lifting is used according to energy storage requirements or maintenance requirements;
layer-by-layer transportation refers to connecting the underground reservoirs and hydraulic turbine rooms on each layer to make the water body flow layer by layer;
direct lifting refers to cutting off the connection between the upper reservoir and the intermediate reservoir with the hydraulic turbine room by closing the sluice gate close to the hydraulic turbine room, so that the water body in the lower reservoir is directly allocated to the surface reservoir and flows through the third-stage hydraulic turbine room for energy storage;
when the remaining electric energy of the power grid is small, the second-stage hydraulic turbine room or first-stage hydraulic turbine room are used for energy storage, which includes:
when the second-stage hydraulic turbine room is used, the connection between the intermediate reservoir and the hydraulic turbine room is cut off by closing the sluice gate close to the side of the hydraulic turbine room, so that the water body of the lower reservoir is allocated to the upper reservoir and flows through the second-stage hydraulic turbine room; when the first-stage hydraulic turbine room is used, the water body is only allocated between adjacent layers.

Therefore, the present disclosure adopts the above-mentioned graded underground pumped-storage hydropower in a coal mine, construction and using methods, and the technical effects are as follows:
(1) In the present disclosure, the resources of the goaf in coal mines are fully utilized. By relying on constructional backfill mining and controlling rock strata movement, a considerable amount of regular underground space is made, which saves land use on the surface and prevents surface subsidence. It is conducive to environmental protection.
(2) Compared with underground reservoirs constructed using the fallen method, the underground pumped-storage hydropower constructed using constructional backfill technology have larger storage volume, simpler storage volume calculations, and more convenient leak prevention treatments. Furthermore, the use of multi-stage underground reservoirs allows for flexible allocation of stored water body, thereby maximizing energy utilization.
(3) The underground reservoir constructed by the present disclosure can not only store excess electrical energy from the power grid, but also purify water body and improve water quality through interaction with the surrounding rock strata. Furthermore, a stable underground space can be retained after the underground reservoir is taken out of use, allowing for easy conversion for other applications.
(4) The construction of a graded underground pumped-storage hydropower in coal mines through the present disclosure can maximize the utilization of existing resources and has advantages such as simple operation and easy promotion.

### BRIEF DESCRIPTION OF THE DRAWINGS

FIG. 1 is a schematic diagram of a graded underground pumped-storage hydropower in a coal mine according to the present disclosure.

FIG. 2 is a partial schematic diagram of a graded underground pumped-storage hydropower in a coal mine according to the present disclosure;

FIG. 3 is a side view of a graded underground pumped-storage hydropower in a coal mine according to the present disclosure.

### REFERENCE NUMERALS IN FIGURES

1, a surface reservoir; 2, an underground reservoir; 21, an upper reservoir; 22, an intermediate reservoir; 23, a lower reservoir; 3, a hydraulic turbine room; 31, an upper hydraulic turbine room; 32, an intermediate hydraulic turbine room; 33, a lower hydraulic turbine room; 4, an upward water conveyance passageway; 5, a downward water conveyance passageway; 6, a second water pipeline; 7, a backfill column; 8, a sluice gate; 9, a pedestrian roadway; 10, a production roadway; 11, a first water pipeline.

### DETAILED DESCRIPTION OF THE EMBODIMENTS

The technical scheme of the present disclosure is further explained below by drawings and embodiments.

Unless otherwise defined, the technical or scientific terms used in the present disclosure shall be those to which the present disclosure belongs.

### Embodiment 1

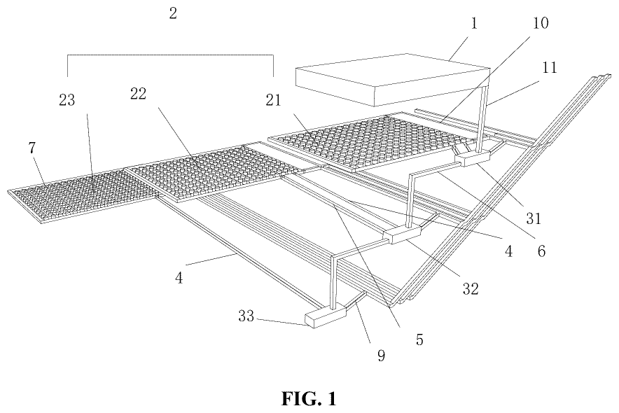

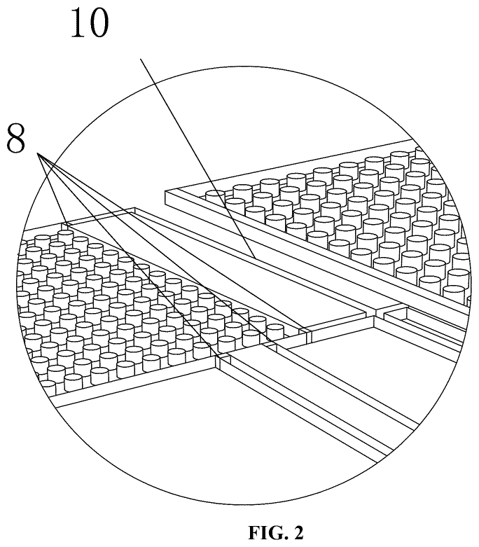

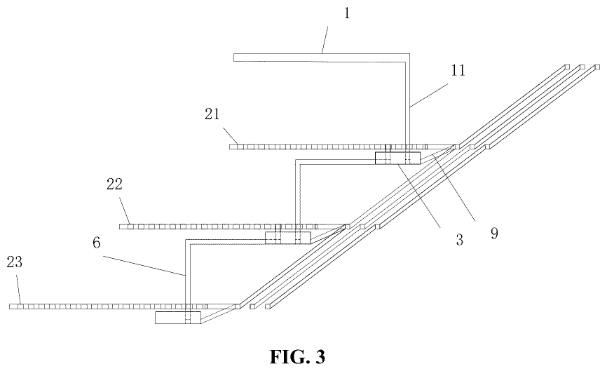

As shown in FIG. 1, FIG. 2, and FIG. 3, a graded underground pumped-storage hydropower in a coal mine is provided, which includes the surface reservoir 1, wherein multi-stage stepped underground reservoirs 2 are arranged below the surface reservoir. In practice, multi-stage upper reservoirs 21 and lower reservoirs 23 can be constructed as required to form a multi-layer water storage system. When necessary, the surface reservoir 1 can be constructed on the surface in accordance with regulations and requirements to achieve the objectives of increasing power generation capacity, increasing reservoir storage volume, and testing water quality.

There is no communication between the multi-stage stepped underground reservoirs 2, and a predetermined distance is arranged between each layer of the underground reservoirs 2.

One side of the underground reservoir 2 on each layer is provided with the hydraulic turbine room 3, the position of the hydraulic turbine room 3 is slightly lower than the position of the underground reservoir 2 on that layer. And the upward water conveyance passageway 4 and the downward water conveyance passageway 5 are arranged between the hydraulic turbine room 3 and the underground reservoir 2, the upward water conveyance passageway 4 and the downward water conveyance passageway 5 are communicated with the hydraulic turbine room 3 and the underground reservoir 2.

The second water pipeline 6 is arranged between the hydraulic turbine rooms 3 among the layers; the first water pipeline 11 is arranged between the surface reservoir 1 and the first layer hydraulic turbine room 3.

One end of the underground reservoir 2 on each layer is provided with the production roadway 10 and the pedestrian roadway 9, and the sluice gates 8 are arranged at the connections among the production roadway 10, the pedestrian roadway 9, the upward water conveyance passageway 4, the downward water conveyance passageway 5 and the underground reservoir 2.

The pedestrian roadway 9 is further communicated to the hydraulic turbine room 3.

The other side of the underground reservoir 2 is provided with the backfill column, the backfill column is configured to support the roof of the underground reservoir 2.

A construction method for a graded underground pumped-storage hydropower in a coal mine is provided, which includes the following steps:
the position and the number of underground reservoirs 2 are confirmed based on the geological conditions of the mine, and the roof and floor conditions of the goaf; the roof and the floor of the goaf are required to be hard rock strata and are aquifuge or aquitard, and when the roof and floor conditions are not satisfied, the water-proof material is used to perform the water-proof and anti-leakage treatment on the goaf.

The underground space needs to be flat, and the immediate roof is complete and not easy to break; when establishing underground space, it is required that the selected coal seam is relatively flat and the overlying rock strata is not soft rock strata; in the formed underground space, the surface reservoir 1 is located on the ground, which is mainly configured to improve the power generation capacity and regulate the water level, and can store the mine water purified by the underground reservoir 2.

The width of the protective coal pillar is confirmed based on the mine pressure behavior law, and the mining sequence is planned.

After confirming the position of the underground reservoir 2, the position of the hydraulic turbine room 3 on one side of the underground reservoir 2 in this layer is confirmed, and the pedestrian roadway 9 and the hydraulic turbine room 3 into the rock strata are excavated through the production roadway 10.

Staff can enter and leave the hydraulic turbine room 3 through the pedestrian roadway 9, and when repairing the underground reservoir 2, the underground reservoir 2 water body to be repaired is allocated to other layers of emptying underground reservoir 2 by controlling the opening and closing of the sluice gate 8, and the maintenance personnel enter the underground reservoir 2 through the upward water conveyance passageway 4 and the downward water conveyance passageway 5 for maintenance.

The hydraulic turbine is arranged in the hydraulic turbine room 3. When energy storage is required, the hydraulic turbine consumes electrical energy, the water body in the lower underground reservoir 2 is extracted, and transported to the upper water body, and the electrical energy is converted into the gravitational potential energy of the water body for storage. At this time, the water flow is transported from the upward water conveyance passageway 4 from the underground reservoir 2 to the hydraulic turbine room 3, and transported to the hydraulic turbine room 3 through the second water pipeline 6. When power generation is required, the water body of the upper underground reservoir 2 is transported downward to the hydraulic turbine, and the gravitational potential energy of the water body is converted into electric energy and transported to the power grid. At this time, the water body is transported from the downward water conveyance passageway 5 from the underground reservoir 2 to the hydraulic turbine room 3 on the same layer, and transported to the hydraulic turbine room 3 on the next layer through the second water pipeline 6. In this way, the storage and utilization of energy is achieved. Additionally, the mine water can be reused by lifting the mine water purified by the rock strata to the surface reservoir 1.

The constructional backfill mining is performed on the coal mine based on the confirmed position of the underground reservoir 2, and when coal resources are mined to form the underground reservoir 2, it is backfilled to form the backfill column 7 as required. The backfill column 7 is arranged at intervals at the key position of the goaf (to ensure that the overlying strata do not fall). The diameter of the backfill column is 1˜4 m, and the mining and backfilling in the goaf are performed simultaneously to form an ‘immediate roof-backfill column 7-immediate floor’ structure.

The backfill material used for the backfill column 7 is cemented gangue backfill material or other backfill material that satisfies the load-bearing requirements. When the load-bearing capacity of the backfill material does not satisfy the requirements, the reinforcement materials or components can be added to the backfill material; when the water body in the underground reservoir 2 is a water body containing erosive components, anti-erosion materials can be added according to the erosive components.

Constructional backfill technology refers to the arrangement of backfill column 7 with a diameter of 1-4 m in the key position of goaf, which can exert the load-bearing capacity of goaf roof to bear the pressure of overlying rock strata, control the movement and deformation of overlying rock strata and structural damage, and achieve the objective of preventing roof caving. Through the constructional backfill technology, the ‘immediate roof-backfill column 7-immediate floor’ collaborative bearing structure is formed, and a stable space is formed in the underground goaf. When making the load-bearing structure of backfill column 7, the backfill column 7 can be made by continuous mining and backfilling, which includes the following steps: template plugging, slurry filling, roof filling and other steps.

The backfill material used in backfill column 7 is a cemented gangue backfill material that satisfies the impermeability and corrosion resistance (the main materials are coal gangue, fly ash, cement, water, the ratio is 10:7:3:4). When the load-bearing capacity of the backfill material does not satisfy the requirements, reinforcement materials or components such as steel bars, fibers, steel pipes and steel slag are added to the backfill material to increase the strength of the backfill column 7 to maintain the stability of the goaf. When the water storage body is a water body containing erosive components, anti-erosion materials (such as anti-erosion coatings or anti-erosion components added to the backfill column) can be added according to the erosive components.

The following specific examples illustrate the construction method for the construction of a graded underground pumped-storage hydropower using constructional backfill mining of the present disclosure:
in this example, the buried depth of No. 1 working face is 250-255 m, the buried depth of No. 2 working face is 330-340 m, and the buried depth of No. 3 working face is 400-420 m. The coal seam is relatively flat, and the overlying rock strata are not soft rock strata. An underground reservoir 2 is arranged on the surface as the surface reservoir 1, the No. 1 working face is designed as the upper reservoir 21, the No. 2 working face is designed as the intermediate reservoir 22, and the No. 3 working face is the lower reservoir 23. After the design is completed, the constructional backfill mining is performed on the relevant working face. The length of No. 1 working face is designed to be 200 m, the advancing length is 790 m, and the mining height is 2.8 m. The length of No. 2 working face is designed to be 215 m, the advancing length is 830 m, and the mining height is 2.4 m. The length of No. 3 working face is designed to be 225 m, the advancing length is 850 m, and the mining height is 2.2 m.

The depth of the mine is considered and according to the strength requirements, the backfill column 7 is designed as a cylinder with a diameter of 4 m, a backfill spacing of 3 m, and the material is a cemented gangue backfill column 7 with a 20% fly ash ratio, supplemented by a 6 mm diameter spiral stirrup for reinforcement. The space with a width of 4 m is mined by continuous mining and backfilling every 3 m. The template is built in this space and the spiral stirrup is placed in the template, and the backfill material is pumped into it.

After the backfilling is completed, the backfill column 7 is maintained for 28 days by sprinkling water, so that the backfill column 7 has sufficient strength to obtain the underground space required for the construction of the graded underground pumped-storage hydropower.

Each layer of the underground reservoir 2 is provided with staggered spacing according to mining requirements and safety requirements. When the geological conditions are good, it is set to be a longitudinal staggered spacing-free arrangement. The underground reservoir 2 can be set up with multiple, and there are three in this embodiment, which are the upper reservoir 21, the intermediate reservoir 22 and the lower reservoir 23.

Since each layer of underground reservoir 2 is arranged in strata of different heights, its height difference can be used for energy storage and power generation.

The upward water conveyance passageway 4 and the downward water conveyance passageway 5 between the hydraulic turbine room 3 and the underground reservoir 2 on each layer are excavated; the second water pipelines 6 between the hydraulic turbine room 3 among layers are excavated; the first water pipelines 11 between the surface reservoir 1 and the first layer hydraulic turbine room 3 are excavated; there is no requirement to construct the downward water conveyance passageway in the underground reservoir 2 at the lowest layer.

Sluice gates 8 are arranged at both ends of the first water pipeline 11, the second water pipeline 6, the upward water conveyance passageway 4 and the downward conveyance water pipeline 5.

Each layer of underground reservoir 2 is provided with a hydraulic turbine room 3. The second water pipelines 6 are arranged between the underground reservoir 2 with the upward water conveyance passageway 4 and the downward water conveyance passageway 5 of the hydraulic turbine room 3, as well as between each layer of the hydraulic turbine room 3, thereby constituting communication between water bodies at each layer. Sluice gates 8 are mounted at the ends of the upward water conveyance passageway 4, the downward water conveyance passageway 5, the first water pipeline 11 and the second water pipeline 6 to control the water flow and the communication of each part of the water body.

The anti-leakage treatment is performed on the goaf and connections of various parts to prevent water body leakage, and a well-constructed graded underground pumped-storage hydropower is obtained. For rock strata with poor water-resistant capacity, water-proof treatment can also be applied to prevent water loss in the underground reservoir and communication between the water body of the underground reservoir 2 and the groundwater system, thereby avoiding sudden water outburst accidents. The water-proof layer can be made of a single layer of water-proof concrete mortar with a thickness of 100 mm to 200 mm, which is arranged around the rock walls and the roof and floor of the underground space using a spraying method. Other water-proof materials, such as water-proof foam or water-proof membranes, can also be arranged on the floor and surrounding rock surfaces of the underground reservoir 2. Additionally, when the underground reservoir 2 in the lower layer is relatively deep, the water contained within it can also serve as a geothermal heat storage medium. By modifying the hydraulic turbine room 3, the objective of collecting geothermal resources can be achieved.

The anti-leakage treatment includes one or more of arranging the water-proof foam layer, spraying water-proof concrete and laying water-proof materials. The purpose is to prevent the water body in the underground reservoir 2 from communicating with the aquifer in the rock stratum and other working faces, and to prevent water outburst accidents.

The water body in the underground reservoir is derived from fault water, aquifer water, and goaf water.

The storage volume of underground reservoir 2 is

$$V = H * ( S - n π {r}^{2} ) ;$$

in the formula, V denotes the storage volume of groundwater reservoir 2, H denotes the mining height of groundwater reservoir 2, S denotes the bottom area of the goaf of groundwater reservoir 2, n denotes the number of backfill columns 7 in groundwater reservoir 2, and r denotes the radius of backfill column 7 in groundwater reservoir 2.

The expression for calculating the water storage volume during operation is:

$$V = h * ( S - n π {r}^{2} ) ;$$

in the formula, h denotes the height of the water body in underground reservoir 2.

The energy storage calculation formula is:

$$P = Sh ρ gl ( 1 - a ) b ;$$

in the formula, ρ denotes the density of the water body, g denotes the gravitational acceleration, l denotes the distance between adjacent strata of groundwater reservoir 2, a denotes the energy loss rate of the water body, and b denotes the power generation efficiency of the hydraulic turbine.

Storage volume calculation: the distance between the surface reservoir 1 and the upper reservoir 21 is designed to be l₀=250 m; the distance between the upper reservoir 21 and the intermediate reservoir 22 is designed to be l₁=85 m; the distance between intermediate reservoir 22 and lower reservoir 23 is l₂=80 m; the density of the energy storage water body is ρ=1500 kg/m³; the energy loss rate of the water body is a=10%; the efficiency of the hydraulic turbine generator is b=80%; and the gravitational acceleration is g=9.8 m/s².

Based on the parameters of each layer of the underground reservoir 2, the water storage capacity of the underground reservoir can be calculated:
the water storage capacity V₀ of the surface reservoir 1 is:

$$200 * 3 * 550 = 330000 {m}^{3} ;$$

the water storage capacity V₁ of the upper reservoir 21 is:

$$200 * 790 * 2.8 - 2 * 2 * π * 2.8 * 3277 = 327096.01 {m}^{3} ;$$

the water storage capacity V₂ of intermediate reservoir 22 is:

$$215 * 830 * 2.4 - 2 * 2 * π * 2.4 * 3689 = 317022.38 {m}^{3} ;$$

the water storage capacity V₃ of the lower reservoir 23 is:

$$220 * 850 * 2.2 - 2 * 2 * π * 2.2 * 4026 = 309447.14 {m}^{3} .$$

Based on the parameters of each layer of the underground reservoir 2, the maximum energy storage capacity of the underground reservoir can be calculated:
the energy storage capacity P₀ of the surface reservoir 1 is:

$${P}_{0} = 330000 * 1500 * 9.8 * 250 * ( 1 - 0.1 ) * 0.8 = 873180 MJ ;$$

the energy storage capacity P₁ of the upper reservoir 21 is:

$${P}_{1} = 31 7022.38 * 1500 * 9.8 * 85 * ( 1 - 0.1 ) * 0.8 = 294268.65 MJ ;$$

the energy storage capacity P₂ of intermediate reservoir 22 is:

$${P}_{2} = 30 9447.14 * 1500 * 9.8 * 85 * ( 1 - 0.1 ) * 0.8 = 285206.01 MJ .$$

Detailed data for each layer of the underground reservoir 2 is shown in Table 1 below:

TABLE 1
Tables of reservoir parameters at all stages

| | | | | | Water |
|---|---|---|---|---|---|
| | | | | Number of | storage |
| | Length | Width | Height | backfill | capacity |
| | (m) | (m) | (m) | columns | (m³) |
| Surface | 200 | 550 | 3 | 0 | 330000 |
| reservoir | | | | | |
| Upper | 200 | 790 | 2.8 | 3277 | 327096.0098 |
| reservoir | | | | | |
| Intermediate | 215 | 830 | 2.4 | 3689 | 317022.3811 |
| reservoir | | | | | |
| Lower | 225 | 850 | 2.2 | 4026 | 309447.1422 |
| reservoir | | | | | |

According to the design, the hydraulic turbine room 3 and the pedestrian roadway 9 are excavated during the roadway excavation, and according to the design, the surface reservoir 1 is constructed on the surface, and the underground space required for the underground reservoir 2 is constructed through the constructional backfill mining. The upward water conveyance passageway 4 and the downward water conveyance passageway 5 are constructed by excavating roadways in the corresponding strata of each layer of underground reservoir 2, connecting each layer of underground reservoir 2 with the corresponding layer of hydraulic turbine room 3, and the second water pipeline 6 is arranged in the hydraulic turbine room 3, and the sluice gate 8 is arranged to prevent the water body in each layer of underground reservoir 2 from invading the pedestrian roadway 9 and the production roadway 10. Upward water conveyance passageway 4 and downward water conveyance passageway 5 can be configured as maintenance roadways in the future. The cross-section size of the upward water conveyance passageway 4 and the downward water conveyance passageway 5 is 3 m*3 m, and the diameter of the water pipeline 6 is 1 m.

After the mining of other working faces (goaf) near the design working face (goaf) is completed or verified that it will not affect the working face (goaf) designed as underground reservoir 2, during maintenance, it passes through the pedestrian roadway 9 to the hydraulic turbine room 3, and from the hydraulic turbine room 3, it passes through the upward water conveyance passageway 4 or the downward water conveyance passageway 5, and enters the underground reservoir 2 of each layer. In the underground reservoir 2, the inner wall, the roof and the floor of the underground reservoir 2 are treated to prevent leakage, and the cracks in the underground reservoir 2 are sealed by laying water-proof materials and spraying water-proof concrete to prevent the water body in the underground reservoir 2 from communicating with the external water body.

Once the above work has been completed, mine water and other water from the coal mining process can be injected into the underground pumped-storage hydropower to complete the construction of a graded underground pumped-storage hydropower in the coal mine.

A using method for a graded underground pumped-storage hydropower in a coal mine is provided, the method includes:

The underground reservoir 2 of each layer and the hydraulic turbine room 3 are interconnected by the upward water conveyance passageway 4, the downward water conveyance passageway 5 and the second water pipeline 6, so that the water body in the underground reservoir 2 can flow between the underground reservoir 2 and the hydraulic turbine room 3 through the water conveyance passageway, and is lifted or released between the hydraulic turbine room 3 of each layer through the water pipeline 6, and energy storage or power generation is performed in the process. When the multi-layer underground reservoir 2 is adopted, the water body in the multi-layer underground reservoir 2 can be flexibly allocated according to the requirements. Additionally, it is necessary to ensure that at least one layer of the underground water reservoir 2 is in an unoccupied state to facilitate maintenance and maintain the normal operation of the underground pumped-storage hydropower.

The water source in the pumping water system comes from underground, including fault water, aquifer water and goaf water, so as to avoid lifting mine water to the surface for treatment, and at the same time, and it is convenient to store mine water generated in the mine production process.

During the use of the underground pumped-storage hydropower, cross-stage transportation can be achieved as required. Graded underground pumped-storage hydropower refers to cross-stage transportation of energy storage media as required, that is, transportation can be achieved between adjacent underground reservoirs and non-adjacent underground reservoirs, such as:
when a power generation capacity of a power grid is lower than a power load, a graded power generation function is started:
when the power load is high, the third-stage hydraulic turbine room 3 is started to generate electricity, and the connection between the upper reservoir 21 and the intermediate reservoir 22 with the upper hydraulic turbine room 31 and intermediate hydraulic turbine room 32 is cut off by closing the sluice gate 8 close to the side of the upper hydraulic turbine room 31 and intermediate hydraulic turbine room 32, so that the water body of the surface reservoir 1 is directly allocated to the lower hydraulic turbine room 33 of the corresponding layer of the lower reservoir 23, and flows through the upper hydraulic turbine room 31, intermediate hydraulic turbine room 32, and lower hydraulic turbine room 33, in total three stages of hydraulic turbine rooms for maximum power generation;
when the power load is low, the second-stage hydraulic turbine room 3 or the first-stage hydraulic turbine room 3 is started to generate electricity; when the second-stage hydraulic turbine room 3 is used, the sluice gate 8 close to the side of the intermediate hydraulic turbine room 32 is closed, the connection between the intermediate reservoir 22 and the intermediate hydraulic turbine room 32 is cut off, and the water body of the upper reservoir 21 is allocated to the lower reservoir 23 and flows through the second-stage hydraulic turbine room; when the first-stage hydraulic turbine room is used, it is only necessary to allocate water body between adjacent layers to achieve power generation at a relatively low power level.

When the power generation capacity of the power grid is higher than the power load, the graded energy storage function is started.

When there is a lot of remaining electric energy in the power grid, the third-stage hydraulic turbine room 3 is used for energy storage, and the layer-by-layer transportation or the direct lifting is used according to energy storage requirements or maintenance requirements.

Layer-by-layer transportation refers to connecting the underground reservoirs 2 and hydraulic turbine rooms 3 on each layer to make the water body flow layer by layer, which fully utilizes each layer of the reservoir, prevents water from concentrating in a single layer, thus reducing flexibility in water allocation.

Direct lifting refers to cutting off the connection between the upper reservoir 21 and the intermediate reservoir 22 with the upper hydraulic turbine room 31 and the intermediate hydraulic turbine room 32 by closing the sluice gate 8 close to the side of the upper hydraulic turbine room 31 and the intermediate hydraulic turbine room 32, so that the water body in the lower reservoir 23 is directly allocated to the surface reservoir 1 and flows through the lower hydraulic turbine room 33, intermediate hydraulic turbine room 32, and upper hydraulic turbine room 31, in total three stages of hydraulic turbine rooms 3 or energy storage. This method prevents water from entering the upper reservoir 21 and intermediate reservoir 22, and allows the upper reservoir 21 or intermediate reservoir 22 to retain their energy storage capacity during maintenance.

when the remaining electric energy of the power grid is small, the second-stage hydraulic turbine room 3 or the first-stage hydraulic turbine room 3 is used for energy storage, which includes:
when the second-stage hydraulic turbine room 3 is used, the connection between the intermediate reservoir 22 and the intermediate hydraulic turbine room 32 is cut off by closing the sluice gate 8 close to the side of the intermediate hydraulic turbine room 32, so that the water body of the lower reservoir 23 is allocated to the upper reservoir 21 and flows through the lower hydraulic turbine room 33 and intermediate hydraulic turbine room 32; when the first-stage hydraulic turbine room 3 is used, the water body is only allocated between adjacent layers to achieve energy storage at a relatively low power level.

The flow direction and flow rate of the energy storage medium are reasonably regulated based on the opening and closing degree of sluice gate 8 to satisfy the requirements of different power generation and energy storage rates.

The future maintenance of underground reservoir 2 can be performed by draining the water body in underground reservoir 2 to be maintained, and allowing staff to enter and exit through the upward water conveyance passageway 4 and the downward water conveyance passageway 5.

Therefore, the present disclosure adopts the above-mentioned graded underground pumped-storage hydropower in a coal mine, construction and using methods. By reasonably planning the coal mine, constructional backfill mining is performed, and the underground space of the coal mine is obtained. Leveraging its advantages of a stable internal environment, low impact from the surface environment, and abundant spatial resources, the construction of the graded underground pumped-storage hydropower is performed. And flexible functional allocation is achieved.

Finally, it should be noted that the above embodiments are merely used for describing the technical solutions of the present disclosure, rather than limiting the same. Although the present disclosure has been described in detail with reference to the preferred examples, those of ordinary skill in the art should understand that the technical solutions of the present disclosure may still be modified or equivalently replaced. However, these modifications or substitutions should not make the modified technical solutions deviate from the spirit and scope of the technical solutions of the present disclosure.

What is claimed is:

1. A method of constructing graded underground pumped-storage hydropower in a coal mine, comprising:
confirming a position and a number of one or more underground reservoirs based on geological conditions of a mine, and roof and floor conditions of a working face;
confirming a width of a protective coal pillar between a production roadway and the working face based on a mine pressure behavior law, and planning a mining sequence;
after confirming the position of the one or more underground reservoirs, confirming a position of a hydraulic turbine room on one side of an underground reservoir in this layer, and excavating a pedestrian roadway to the hydraulic turbine room through the rock strata from the production roadway;
performing a constructional backfill mining on the coal mine based on the confirmed position of the underground reservoir, and when coal resources are mined to form the underground reservoir, it is backfilled to form a backfill column as required;
excavating an upward water conveyance passageway and a downward water conveyance passageway between the hydraulic turbine room and the underground reservoir on each layer; excavating a second water pipeline between the hydraulic turbine room among layers; excavating a first water pipeline between a surface reservoir and a first layer hydraulic turbine room; there is no requirement to construct a downward water conveyance passageway in the underground reservoir at a lowest layer;
arranging sluice gates at both ends of the first water pipeline, the second water pipeline, the upward water conveyance passageway and the downward water conveyance passageway; and
performing an anti-leakage treatment on a goaf to prevent water body leakage, thus obtaining a graded underground pumped-storage hydropower system.

2. The method of constructing graded underground pumped-storage hydropower in a coal mine according to claim 1, wherein a roof and a floor of the goaf are required to be hard rock strata and are aquifuge or aquitard, wherein a water-proof material is used to perform the anti-leakage treatment on the goaf; and wherein the anti-leakage treatment comprises one or more of arranging a water-proof foam layer, spraying water-proof concrete and laying water-proof materials.

3. The method of constructing graded underground pumped-storage hydropower in a coal mine according to claim 1, wherein each layer of the underground reservoir is provided with a staggered spacing according to mining requirements and safety requirements, and each layer of the underground reservoir is further provided with a longitudinal staggered spacing-free arrangement.

4. The method of constructing graded underground pumped-storage hydropower in a coal mine according to claim 1, wherein the goaf is formed in the mining of the working face, and the mining and backfilling of the working face are performed simultaneously, the backfill column is formed by backfilling, and an immediate roof-backfill column-immediate floor structure is formed, wherein the backfill columns are arranged at intervals in the goaf, and a diameter of the backfill column is 1˜4 m.

5. The method of constructing graded underground pumped-storage hydropower in a coal mine according to claim 1, wherein the hydraulic turbine room is located below a level of the underground reservoir of each layer and is arranged in the rock stratum.

6. The method of constructing graded underground pumped-storage hydropower in a coal mine according to claim 1, wherein a water body in the underground reservoir is derived from fault water, aquifer water, or goaf water.

7. method of constructing graded underground pumped-storage hydropower in a coal mine according to claim 1, wherein a communication between the reservoir and the hydraulic turbine room is controlled by opening and closing the sluice gate, thereby controlling a number of stages of the hydraulic turbine room that the water flows through.

8. A graded underground pumped-storage hydropower system in a coal mine, comprising a surface reservoir, wherein multi-stage stepped underground reservoirs are arranged below the surface reservoir, and there is no communication between the multi-stage stepped underground reservoirs;
wherein one side of the underground reservoir on each layer is provided with a hydraulic turbine room, and an upward water conveyance passageway and a downward water conveyance passageway are arranged between the hydraulic turbine room and the underground reservoir;
wherein a second water conveyance passageway is arranged between the hydraulic turbine rooms among the layers; and the first water conveyance passageway is arranged between the surface reservoir and the first layer hydraulic turbine room;
wherein one end of the underground reservoir on each layer is provided with a production roadway and a pedestrian roadway, and sluice gates are arranged at connections among the production roadway, the pedestrian roadway, the upward water conveyance passageway, the downward water conveyance passageway and the underground reservoir;
wherein the pedestrian roadway is further communicated with the hydraulic turbine room;
and wherein the other side of the underground reservoir is provided with a backfill column, and the backfill column is configured to support the roof of the underground reservoir.

9. A method of use of the graded underground pumped-storage hydropower system in a coal mine according to claim 8, wherein when the underground reservoir is has three grades, comprising an upper reservoir, an intermediate reservoir and a lower reservoir;
wherein when a power generation capacity of a power grid is lower than a power load, a graded power generation function is started:
wherein, when the power load is high, a third-stage hydraulic turbine room is used to generate electricity, and the connection between the upper reservoir and the intermediate reservoir with the hydraulic turbine room is cut off by closing the sluice gate close to a side of the hydraulic turbine room, so that the water body of the surface reservoir is directly allocated to the hydraulic turbine room of the corresponding layer of the lower reservoir, and flows through the third-stage hydraulic turbine room for maximum power generation;
wherein, when the power load is low, a second-stage hydraulic turbine room or first-stage hydraulic turbine room is used to generate electricity; wherein, when the second-stage hydraulic turbine room is used, the sluice gate close to a side of the hydraulic turbine room is closed, a connection between the intermediate reservoir and the hydraulic turbine room is cut off, and the water body of the upper reservoir allocated to the lower reservoir and flows through the second-stage hydraulic turbine room; when the first-stage hydraulic turbine room is used, the water body is only allocated between adjacent layers.

10. The method of use of the graded underground pumped-storage hydropower system in a coal mine according to claim 9, wherein when the power generation capacity of the power grid is higher than the power load, the graded energy storage function is started, comprising:
when there is a lot of remaining electric energy in the power grid, the third-stage hydraulic turbine room is used for energy storage, and a layer-by-layer transportation or direct lifting is used according to energy storage requirements or maintenance requirements;
wherein layer-by-layer transportation refers to connecting the underground reservoirs and hydraulic turbine rooms on each layer to make the water body flow layer by layer;
wherein direct lifting refers to cutting off the connection between the upper reservoir and the intermediate reservoir with the hydraulic turbine room by closing the sluice gate close to the hydraulic turbine room, so that the water body in the lower reservoir is directly allocated to the surface reservoir and flows through the third-stage hydraulic turbine room for energy storage;
wherein when the remaining electric energy of the power grid is small, the second-stage hydraulic turbine room or first-stage hydraulic turbine room are used for energy storage, comprising:
when the second-stage hydraulic turbine room is used, the connection between the intermediate reservoir and the hydraulic turbine room is cut off by closing the sluice gate close to the side of the hydraulic turbine room, so that the water body of the lower reservoir is allocated to the upper reservoir and flows through the second-stage hydraulic turbine room; and, when the first-stage hydraulic turbine room is used, the water body is only allocated between adjacent layers.
